(19) United States
(12) Patent Application Publication
(10) Pub. No.: US 2014/0132394 A1
(43) Pub. Date: May 15, 2014

(54) SYSTEM AND METHOD FOR TOOL LOCATION

(71) Applicants: Carlos Olivarez, Marlin, TX (US); Manuel Bautista, Marlin, TX (US)

(72) Inventors: Carlos Olivarez, Marlin, TX (US); Manuel Bautista, Marlin, TX (US)

(21) Appl. No.: 13/674,572

(22) Filed: Nov. 12, 2012

(51) Int. Cl. G08B 3/10

(52) U.S. Cl. CPC G08B 3/1041
USPC 340/8.1

(57) ABSTRACT

A system for locating a plurality of tools including a receiver; a proximity lighting system on the receiver; an input means on the receiver; a display monitor, where the monitor displays any input; a memory means within the receiver, where the memory means stores data; and a sensor on the receiver for receiving RF signals. An audio speaker is also provided on the receiver in order to emit sounds. A transmitter and a scanning code may be affixed to an object, where the transmitter emits a unique RF signal and the scanning code is associated with a unique ID for the object. The scanning code may be stored in the memory means of the receiver.

### BACKGROUND OF THE INVENTION

1. Field of Invention

The present invention relates to a system and method to locate tools electronically using RF signals and GPS signaling.

2. Description of Related Art

The necessity to locate items is always a problem that faces many individuals and in particular workers. Many times individuals must attempt to locate lost keys, wallets, purses, remote controls and other small items that may be within a household or office. Workers commonly deal with lost materials, parts or tools that may be necessary to accomplish various tasks. Methods have been developed to locate such items by implementing radio frequency systems that transmit signals to indicate the location of the misplaced or lost item. Normally there is a handheld receiver or transmitter that receives or sends a constant signal from or to the lost item. These systems have been used to conveniently help individuals locate any misplaced item. Normally with the locating systems of the prior art a single RF signal is transmitted between the transmitter and receiver in order to assist the individual in locating item. An individual who works with multiple hand tools may actually discover that the particular hand tool is missing long after the item has been misplaced. Further individuals working with hand tools normally will have a large variety of tools that may be used in their workplace to accomplish various tasks such as various nuts, ratchets, bolts, wrenches, drill bits or bit replacements. Consequently, a need exists to inventory the entire set of tools with a receiver and have the ability to locate any item within the stored inventory of the receiver. Such a system could assist in the identifying a plurality of specific tools that may be missing instead of the limited locating systems of the prior art.

### SUMMARY OF THE INVENTION

In view of the foregoing disadvantages inherent in the prior art, the general purpose of the present invention is to provide a system to locate objects, configured to include all of the advantages of the prior art, and to overcome the drawbacks inherent therein.

Accordingly, an object of the present invention is to provide a system that catalogs a plurality of objects into a receiver to later determine the object's location as needed by the user.

Another object of the present invention is to provide a system that when locating an object the proximity to the object is narrowed as the receiver gets closer.

To achieve the above objects, in an aspect of the present invention, a system for locating a plurality of tools is described comprising a receiver; a proximity lighting system on the receiver; an input means on the receiver; a display monitor, where the monitor displays any input; a memory means within the receiver, where the memory means stores data; a sensor on the receiver for receiving RF signals; an audio speaker on the receiver for emitted sounds; a transmitter affixed to an object, where the transmitter emits a unique RF signal; and a scanning code affixed to the object, where the code is associated with a unique ID for the object and where the code is stored in the memory means.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF DRAWINGS

FIG. 1 depicts a transmitter used in accordance with the present invention.

FIG. 2 depicts a receiver used in accordance with the present invention.

FIG. 3 depicts a transmitter placed upon an exemplary tool used in accordance with the present invention.

### DETAILED DESCRIPTION

The present invention relates to a system and method for locating a tool that has been misplaced or lost. The present invention utilizes radio frequency and GPS technology to locate a particular tool that has been stored within the memory of the receiver. The receiver provides the system to approximate the location of the tool using a three light system along with audio sound to locate the tool. The tool includes a transmitter attached to the tool and a scanning code that is also attached to the tool. The user may scan the tool into the memory of the receiver, where the tool is identified with a tool I.D. number and unique RF signal is stored in the memory of the receiver. The present invention allows the user to individually identify each tool, store and associate a RF signal associated with each particular tool. This system allows the user to locate a specific tool that is missing or may also enable the location of the multiple tools that are missing one at a time. The lighting system used on the receiver provides an indication of the proximity of the tool from the receiver. As one gets closer to the tool the light signaling changes based upon proximity and when the receiver is closest to the tool audible signals are transmitted through the receiver.

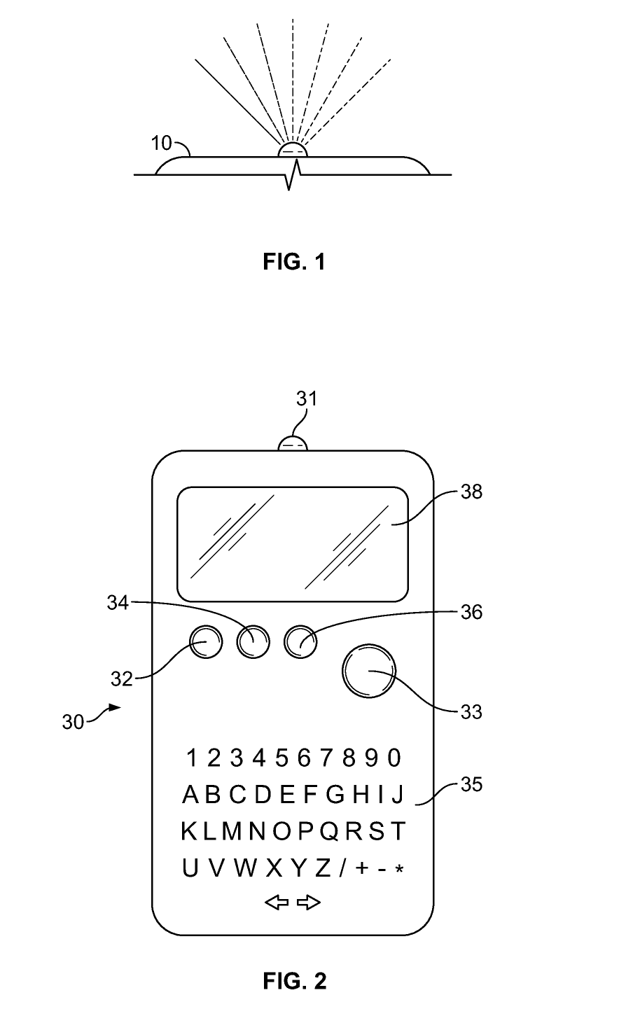

FIG. 1 depicts a transmitter 10 used in accordance with the present invention. The transmitter 10 may be placed upon any tool or in a broader embodiment any object desired to be inventoried and catalogued by the receiver. Once the transmitter 10 is placed upon the object it may be activated to transmit RF signals to be received by a handheld receiver. FIG. 2 depicts a handheld receiver 30 used in accordance with the present invention. The handheld receiver 30 includes various functions to assist in location of a tool that has been catalogued within the memory of the receiver 30.

Features of the handheld receiver 30 include a keyboard 35 for the input of alphanumeric characters into the receiver. A series of three lights are also provided on the front panel of the receiver 30. A red light 32, a yellow light 34, and a green light 36 are provided on the front panel of the receiver 30. Further audio speaker 33 is provided which transmits audio sounds to assist in the location of tools in accordance with the present invention. A monitor 38 is also provided on the front surface of the receiver 30 that allows for the display of the tool I.D. that may be located through the use of the receiver 30. A signal 31 is also provided on one side of the receiver 30 that receives the RF signal transmitted by any transmitter used in accordance with the present invention.

The receiver 30 provides an indication of the location of missing tools by receiving the RF signal transmitted by the transmitter placed upon each tool within the catalog system. The red light indicates a particular proximity of the tool in relation to the receiver. The red light may indicate the furthest distance away from the tool and in one particular embodiment the distance may range from 50 to about 100 feet. The yellow light provides a closer indication of proximity between the receiver and the transmitter. In one particular embodiment the yellow light provides an indication that the receiver is about 25 to 50 feet away from the transmitter or missing object. The green light 36 provides an indication that the receiver may be anywhere from 1 to 25 feet from the missing object which holds the transmitter. As one gets even closer to the object an audio beeping sound provides an indication that the transmitter and receiver are less than 1 foot apart in distance.

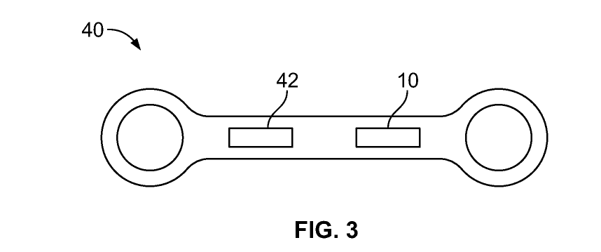

FIG. 3 depicts use of the transmitter 10 upon a tool 40. As shown in FIG. 3, the transmitter 10 is placed upon the tool along with a barcode or scanning code 42. The scanning code 42 allows an individual to easily scan a unique I.D. associated with the tool 40. This unique I.D. may be stored in the memory of the receiver and a unique RF signal is associated with the tool 40. This application of the transmitter 10 upon a tool may be repeated a plurality of times on each and every object that is stored in the memory of the receiver 30. Once the unique I.D. and RF signal are associated with each individual tool the user has a complete catalog of tools that may be located with the receiver 30. If any tool or object catalogued within the receiver 30 is misplaced or lost the individual only needs to input the unique I.D. by using the keypad 35 associated with the receiver 30. The input is shown upon the monitor 38 as the individual inputs the unique I.D. Once the unique I.D. is input the receiver is activated to receive RF signals associated with the particular object that is being located by the receiver.

The lighting scheme as discussed above provides the proximate distance between the receiver 30 and the transmitter 10 that is misplaced or lost. This tool finding system according to present invention is very helpful in a commercial facility and also could be adapted for use for homeowners who have multiple objects that they desire to locate through the use of a central receiver. Other applications may include the retrieval of a golf ball based upon the same transmitting and code identification system as set forth above. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for locating a plurality of tools comprising:
a. a receiver;
b. a proximity lighting scheme on the receiver;
c. an input means on the receiver;
d. a display monitor on the receiver, where the monitor displays any input;
e. a memory means within the receiver, where the memory means stores data;
f. a sensor on the receiver, where the sensor receives RF signals;
g. an audio speaker on the receiver, where the audio speaker emits sounds;
h. a transmitter affixed to an object, where the transmitter emits a unique RF signal; and
i. a scanning code affixed to the object, where the code is associated with a unique ID for the object and where the code is stored in the memory means.

2. The system for locating a plurality of tools according to claim 1, where the proximity lighting scheme includes a red light, a yellow light and a green light, where the proximity lighting scheme changes through a sequence of red to yellow to green as proximity to the object nears.

3. The system for locating a plurality of tools according to claim 1, where the memory stores each unique IDs to create a catalog of objects.

4. The system for locating a plurality of tools according to claim 1, where the input means includes a keyboard of alphanumeric characters.

5. A method of use for a system for locating a plurality of tools comprising the steps of:
a. affixing a scanning code associated with a unique ID on an object;
b. affixing a transmitter on the object, where the transmitter emits a unique RF signal associated the unique ID;
c. scanning the scanning code with a receiver;
d. storing the scanning code into a memory within the receiver; and
e. locating the object by:
i. inputting the scanning code into an input means,
ii. receiving a RF signal into the receiver;
iii. determining proximity of the object with a proximity lighting scheme; and
iv. determining an object location by using an audio beeping sound transmitted from the receiver to indicate when the receiver is less than one foot from the object.

6. The method of use for a system for locating a plurality of tools according to claim 1, further comprising the step of following the proximity lighting scheme as it changes from a red light, to a yellow light to a green light as the location of the object nears.
